(19) United States
(12) Patent Application Publication
(10) Pub. No.: US 2010/0300979 A1
(43) Pub. Date: Dec. 2, 2010

(54) DEWATERING OF SILICATE WELLBORE FLUIDS

(75) Inventors: Alan Gilmour, Houston, TX (US); Arvind D. Patel, Sugar Land, TX (US)

Correspondence Address: OSHA LIANG/MI, TWO HOUSTON CENTER, 909 FANNIN STREET, SUITE 3500, HOUSTON, TX, 77010, US

(73) Assignee: M-I LLC, Houston, TX (US)

(21) Appl. No.: 12/744,732

(22) PCT Filed: Nov. 19, 2008
(86) PCT No.: PCT/US08/84025

§ 371 Date: May 26, 2010

Related U.S. Application Data
(60) Provisional application No. 60/991,112, filed on Nov. 29, 2007.

(51) Int. Cl. B01D 21/01

(52) U.S. Cl. 210/712

(57) ABSTRACT

A method of treating silicate-based wellbore fluids that includes flocculating at least a portion of contaminants contained in a silicate-based wellbore fluid out of the fluid phase; and separating the flocculated contaminants from the fluid phase. Methods of recycling silicate-based fluids, methods of disposing used silicate-based fluid, and methods of disposing of wellbore fluid waste are also disclosed.

### BACKGROUND OF INVENTION

1. Field of the Invention

Embodiments disclosed herein relate generally to dewatering of wellbore fluids. In particular, embodiments disclosed herein relate to dewatering of silicate-based wellbore fluids.

2. Background Art

Various fluids are used when drilling or completing a well, and the fluids may be used for a variety of reasons. Common uses for well fluids include: lubrication and cooling of drill bit cutting surfaces while drilling generally or drilling-in (i.e., drilling in a targeted petroliferous formation), transportation of “cuttings” (pieces of formation dislodged by the cutting action of the teeth on a drill bit) to the surface, controlling formation fluid pressure to prevent blowouts, maintaining well stability, suspending solids in the well, minimizing fluid loss into and stabilizing the formation through which the well is being drilled, fracturing the formation in the vicinity of the well, displacing the fluid within the well with another fluid, cleaning the well, testing the well, transmitting hydraulic horsepower to the drill bit, fluid used for emplacing a packer, abandoning the well or preparing the well for abandonment, and otherwise treating the well or the formation.

When returned to the surface, the mud passes through solids control equipment to remove unwanted solids. While larger solids are removed by shale shakers and hydrocyclones, ultra-fine particles (less than about 20 microns) form colloidal suspensions in the fluid and will continue to circulate through the system unless special solids removal equipment is used. The difficulty of removing these small particles increases as the particle size decreases.

Due to increasing environmental concerns and escalating disposal costs, there is growing incentive to reduce the volume of drilling wastes. One way of reducing the drilling waste volume is to reduce the amount of water discharged with solids disposal. Generally, waste management dewatering systems separate solids and fine particles from the liquid phase of drilling fluid, thereby leaving a clarified aqueous solution. In a drilling operation, dewatering allows the cleaning of waste fluids, such as, wellbore fluids mixed with water from the rotary table, mud tanks, mud pumps, generators and from any other discharge point around a drilling rig. Typically, dewatering waste management systems clean drilling fluid through coagulation, flocculation, and/or mechanical separation.

Accordingly, there exists a continuing need for dewatering of a variety of wellbore fluids.

### SUMMARY OF INVENTION

In one aspect, embodiments disclosed herein relate to a method of treating silicate-based wellbore fluids that includes flocculating at least a portion of contaminants contained in a silicate-based wellbore fluid out of the fluid phase; and separating the flocculated contaminants from the fluid phase.

In another aspect, embodiments disclosed herein relate to a method of recycling a silicate-based wellbore fluid that includes adding a flocculant and a polyelectrolyte coagulant to a silicate-based wellbore fluid containing contaminants therein; flocculating at least a portion of the contaminants out of the fluid phase; and separating the silicate-based fluid from the flocculated contaminants.

In another aspect, embodiments disclosed herein relate to a method of disposing of a used silicate-based wellbore fluid that includes lowering a pH of the used silicate-based wellbore fluid; adding a flocculant to the silicate based wellbore fluid; flocculating silicate solids out of the fluid phase; and separating the flocculated silicates from the fluid.

In yet another aspect, embodiments disclosed herein relate to a method of disposing of wellbore fluid waste that includes providing a silicate-based wellbore fluid; determining whether additional drilling with the wellbore fluid is desired; if additional drilling is not desired, adding a flocculant and an inorganic coagulant to the fluid; if additional drilling is desired, adding a flocculant and a polyelectrolyte coagulant to the fluid; separating flocculated solids from the fluid.

Other aspects and advantages of the invention will be apparent from the following description and the appended claims.

### DETAILED DESCRIPTION

In one aspect, embodiments disclosed herein relate to dewatering of wellbore fluids. In particular, embodiments disclosed herein relate to dewatering of silicate-based wellbore fluids.

Silicate-based wellbore fluids have been well-established as an effective means of stabilizing shale formations. Despite being an effective shale stabilizer, silicate never achieved early, widespread success, owing to certain advantages held by oil-based drilling fluids, in particular, the ease of use of oil-based fluids, which are also not prone to gellation or precipitation, and good lubricating properties. Until recent environmental pressures there was little incentive to improve the performance deficiencies in silicate-containing, water-based drilling fluids. Thus, as mud designers have been able to overcome the traditional deficiencies of silicate-based fluids, there has also been an increasing need for disposal of waste generated from the use of silicate-based fluids.

In accordance with embodiments of the present disclosure, dewatering of silicate-based fluids may be provided to reduce the volume of drilling wastes associated with the silicate-based fluids. Such dewatering of silicate-based fluids may occur through coagulation, flocculation, and/or mechanical separation.

Coagulation occurs when the electrostatic charge on a solid is reduced, destabilizing the solid and allowing it to be attracted to other solids by van der Waals forces. However, coagulation is an aggregation of particles on a microscopic level. Flocculation is the binding of individual solid particles into aggregates of multiple particles on a macroscopic. Flocculation is physical, rather than electrical, and occurs when one segment of a flocculating polymer chain absorbs simultaneously onto more than one particle. Mechanical separation includes mechanical devices (e.g., hydrocyclones and centrifuges) that remove solid particles from a solution.

To achieve the precipitation and aggregation of fine precipitates in a fluid (so that physical or mechanical separation of the precipitates from the fluid may occur), a flocculant may be added to a wellbore fluid. Flocculants suitable for use in the dewatering of the fluids of the present disclosure may include for example, high molecular weight (2,000,000-20,000,000) acrylic acid or acrylate-based polymers. The charge density of the polymers may range from 0-100 percent (in either charge direction). In a particular embodiment, the charge density may range from 0-80 percent. Thus, depending on the charges of the monomers, the resulting polymers may be cationic, anionic, or non-ionic. Commercial examples of such polyacryalmide-based flocculants include those sold under the trade names MAGNAFLOC® and ZETAG®, from Ciba Specialty Chemicals (Tarrytown, N.Y.) and HYPERFLOC® from Hychem, Inc. (Tampa, Fla.).

In addition to a flocculant, a coagulant may be used to assist in aggregating colloidal particles within a fluid. The coagulant may be an inorganic or polyelectrolyte type. Most inorganic coagulants will also reduce the pH due to the inherent acidity of the salt. Thus, selection among the two types of coagulants may be based on whether precipitation and removal of silicates from the fluid is desired. If further use in downhole operations, such as drilling, of the silicate-based fluid is desired, a polyelectrolyte coagulant may be selected so that the pH of the fluid does not substantially change. However, if disposal of the fluid is desired, an acidic inorganic coagulant may be selected to reduce the pH of the fluid, and trigger coagulation and flocculation of the silicates within the fluid. In such an instance, the silicates may be disposed of with the remainder of the solid waste, and the fluid (water) may be disposed of, further treated, used in additional operations, etc.

Examples of inorganic coagulants include aluminum- and iron-based coagulants, such as aluminum chloride, poly(aluminum hydroxy)chloride, aluminum sulfate, ferric sulfate, ferric chloride, etc. Further, one of ordinary skill in the art would appreciate that selection of the coagulant may depend, for example, on the pH of the fluid, presence of ions in the fluid, requirements for the final fluid, etc. Commercial examples of various inorganic coagulants include those sold under the trade name SUPERFLOC®, which are poly(aluminum hydroxy)chlorides available from Cytec Industries, Inc. (West Patterson, N.J.).

Examples of polyelectrolyte coagulants include water-soluble organic polymers that may be cationic, anionic, or non-ionic. In a particular embodiment, cationic polymers having molecular weights generally less than 500,000 may be used. However, higher molecular weight polymers (such as up to 20,000,000) may be used in yet other embodiments. The charge density of the polymers may range up to 100 percent. Cationic monomers may include diallyl dialkyl ammonium halides and dialkylaminoalkyl (meth)-acrylates and -acrylamides, (as acid addition or quaternary ammonium salts). In a particular embodiment, the coagulant may include poly diallyl dimethyl ammonium chloride.

Following flocculation of solid materials within a fluid, the flocs may settle to the bottom of a fluid, and be separated therefrom by mechanical means such as a centrifuge. In some embodiments, shaking and/or mixing of a treated fluid (with flocculants and coagulants) may be desirable to optimize solids flocculation formation. However, the level of shaking/mixing may depend on the type of coagulant used. For example, when using polymeric coagulants, gentle shaking or mixing is preferred to mix the polymer therein without affecting the polymers' efficacy at aiding flocculation.

### EXAMPLES

The following example was performed to test the efficacy of dewatering silicate wellbore fluids. A sample silicate wellbore fluid was formulated as shown below in Table 1, and the mud properties tested with a Fann 35 Viscometer from the Fann Instrument Company, shown below in Table 2. FED PAC™, polyanionic cellulose, and FED ZAN™, a zanthan gum, are available from the Federal Division of M-I LLC.

TABLE 1

| Component | Amount |
|---|---|
| Water, bbl | 0.879 |
| Potassium Silicate, ppb | 36.75 |
| Potassium Carbonate, ppb | 0.53 |
| FED PAC UL, ppb | 2.8 |
| FED ZAN D, ppb | 1.05 |
| tetrapotassium pyrophosphate, ppb | 2.6 |
| Cal Carb 0, ppb | 10.5 |
| Cal Carb 325, ppb | 10.5 |
| Rev Dust, ppb | 10.5 |

TABLE 2

| | |
|---|---|
| Mud Weight, ppg | 9.12 |
| Rheology Temp, ° F. | 120 |
| 600 rpm | 39 |
| 300 rpm | 26 |
| 200 rpm | 21 |
| 100 rpm | 15 |
| 6 rpm | 4 |
| 3 rpm | 3 |
| PV, cps | 13 |
| YP, lbs/100 ft² | 13 |
| 10 s gel | 4 |
| 10 m gel | 5 |
| API Filtrate, mL | 7.0 |
| pH | 11.9 |

20 mL samples of the fluid shown in Table 1 were placed in 40 cc vial containers after mixing of the fluid in a Hamilton Beach mixer. The dewatering products shown below in Table 3 were tested by adding them to the fluid, and shaking them while observing for solids flocculation formation. The specific products tested include MAGNAFLOC® 368, a poly diallyl dimethyl ammonium chloride commercially available from Ciba Specialty Chemicals; HYPERFLOC® AF 307, a 30% anionic polyacrylamide from Hychem, Inc.; and aluminum chloride. When adding inorganic coagulants, heavy shaking was use to optimize solids flocculation formation. When adding a polymer coagulant to the fluid, heavy shaking was avoided, and gentle shaking by turning the vials upside down and then right side up (and repeating if necessary) to mix the polymer in the fluid without destroying the polymers' effectiveness at flocculating the solids. The mixing was repeated until flocculation of solids was observed and did not increase in size. Various observations of the dewatering results were made, as detailed below in Table 3.

TABLE 3

| Fluid | | | | | | | | |
|---|---|---|---|---|---|---|---|---|
| | Products | | | | Performance | | | |
| | 2.0% | 0.2% | ml used | mL used | Floc Formation | | Floc Settling | |
| Sample | coag | Floc | coag | Floc | size | rate | Rate | water clarity |
| 1 | MF 368 | AF 307 | 5 | 0.3 | large | fast | fast | clear |
| 2 | MF 368 | AF 307 | 4.25 | 0.3 | small | fast | fast | clear |
| 3 | MF 368 | AF 307 | 3.75 | 0.3 | small | slow | slow | slightly cloudy |
| 4 | AlCl₃ | AF 307 | 7 | 0.8 | small | slow | slow | slightly cloudy |
| 5 | AlCl₃ | AF 307 | 8 | 0.6 | bulky | fast | fast | clear |

As shown in the above results, MAGNAFLOC® in combination with HYPERFLOC® AF 307 dewatered the fluid successfully. In addition, an analytical test of Sample 1 showed that the supernatant contains 1560 mg/L silicate, which represents most (if not all) of the silicate in the fluid, while the solids portion contains very little, if any at all. Aluminum chloride in combination with HYPERFLOC® AF 307 dewatered the silicate fluid successfully as well. An analytical test of Sample 5 showed that the supernatant contains only 160 mg/L silicate, indicating that the remainder of the silicate was flocculated with the solids.

Advantageously, embodiments of the present disclosure for at least one of the following. By providing for methods for dewatering a silicate fluid, reduction of drilling waste volume may be achieved by reducing the amount of water discharged with solids disposal. In particular, the dewatering may separate solids and fine particles from the liquid phase of drilling fluid, thereby leaving a clarified aqueous solution. Further, embodiments of the present disclosure may allow for determination of whether it is desirable to remove silicate from the fluid, allowing for additional flexibility in the end-use of the collected aqueous fluid.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method of treating silicate-based wellbore fluids, comprising:
flocculating at least a portion of contaminants contained in a silicate-based wellbore fluid out of the fluid phase;
separating the flocculated contaminants from the fluid phase to create a separated fluid; and
reusing the separated fluid in a wellbore operation.

2. The method of claim 1, wherein at least a portion of the silicates in the provided fluid are separated with the flocculated contaminants.

3. The method of claim 1, wherein at least a portion of the silicates in the provided fluid are separated with the fluid.

4. The method of claim 1, wherein flocculating comprising adding a flocculant comprised of a copolymer of acrylic acid and/or acrylate compounds to the fluid.

5. The method of claim 4, wherein flocculating further comprises adding a coagulant to the fluid.

6. The method of claim 5, wherein the coagulant comprises an inorganic coagulant.

7. The method of claim 5, wherein the coagulant comprises a polyelectrolyte coagulant.

8. A method of recycling a silicate-based wellbore fluid, comprising:
adding a flocculant and a polyelectrolyte coagulant to a silicate-based wellbore fluid containing contaminants therein;
flocculating at least a portion of the contaminants out of the fluid phase;
separating the silicate-based fluid from the flocculated contaminants; and
reusing the separated silicate-based wellbore fluid.

9. The method of claim 8, wherein the flocculant is comprised of a copolymer of acrylic acid and/or acrylate compounds to the fluid.

10. The method of claim 8, wherein the polyelectrolye coagulant comprises a cationic polymeric coagulant.

11. The method of claim 10, wherein the cationic coagulant comprises a diallyl dialkyl ammonium halide monomer.

12. The method of claim 11, wherein the cationic coagulant comprises poly diallyl dimethyl ammonium chloride.

13. (canceled)

14. A method of disposing of a used silicate-based wellbore fluid, comprising:
lowering a pH of the used silicate-based wellbore fluid;
adding a flocculant to the silicate based wellbore fluid;
flocculating silicate solids out of the fluid phase;
separating the flocculated silicates from the fluid to form a separated fluid; and
reusing the separated fluid.

15. The method of claim 14, further comprising:
disposing of the flocculated silicates.

16. (canceled)

17. (canceled)

18. The method of claim 14, wherein the flocculant is comprised of a copolymer of acrylic acid and/or acrylate compounds to the fluid.

19. The method of claim 14, wherein lowering the pH occurs by adding an inorganic coagulant to the fluid.

20. The method of claim 19, wherein the inorganic coagulant comprises at least one aluminum-based compound.

21. A method of disposing of wellbore fluid waste, comprising:
providing a silicate-based wellbore fluid;
determining whether additional drilling with the wellbore fluid is desired;
if additional drilling is not desired, adding a flocculant and an inorganic coagulant to the fluid;
if additional drilling is desired, adding a flocculant and a polyelectrolyte coagulant to the fluid;
separating flocculated solids from the fluid to form a separated fluid; and
reusing the separated fluid.
